(19) United States
(12) Patent Application Publication
(10) Pub. No.: US 2005/0025952 A1
(43) Pub. Date: Feb. 3, 2005

(54) Heat resistant insulation composite, and method for preparing the same

(75) Inventors: Rex James Field, Worms (DE); Beate Scheidemantel, Hanau (DE)

Correspondence Address: Robert J. Follett, Esq.;Cabot Corporation, Law Department, 157 Concord Road, Billerica, MA, 01821, US

(73) Assignee: Cabot Corporation, Boston, MA (US)

(21) Appl. No.: 10/439,534

(22) Filed: May 15, 2003

Related U.S. Application Data
(60) Provisional application No. 60/380,967, filed on May 15, 2002.

(51) Int. Cl. B32B 3/26

(52) U.S. Cl. 428/304.4

(57) ABSTRACT

The invention provides a heat resistant insulation composite comprising an insulation base layer comprising hollow, non-porous particles and a matrix binder, and a thermally reflective layer comprising a protective binder and an infrared reflecting agent, wherein the heat resistant insulation composite has a thermal conductivity of about 50 mW/(m·K) or less. The invention also provides a method of preparing a heat resistant insulation composite.

### CROSS-REFERENCE TO RELATED PATENT APPLICATIONS

This patent application claims priority to provisional U.S. Patent Application No. 60/380,967 filed on May 15, 2002.

### FIELD OF THE INVENTION

This invention pertains to a heat resistant insulation composite, and method for preparing the same.

### BACKGROUND OF THE INVENTION

Various materials have been used with binder systems to provide particulate-filled binder-type insulation materials. For example, aerogel particles have been combined with aqueous binders to provide insulation materials with good thermal and acoustic insulation properties; however, these systems typically do not provide sufficient durability or heat resistance, and are limited in their formulation to aqueous binders that do not penetrate the hydrophobic pores of the aerogel particle. Also, aerogel materials tend to be more expensive than other types of particulate fillers. Other materials, such as microballoons, perlite, clays, and various other particulate fillers also have been used in combination with binders to provide insulation materials. Some such materials have been used in conjunction with intumescent (e.g., char-forming) layers to provide a certain degree of fire-resistance.

Nevertheless, there remains a need for an insulation article that provides good thermal and/or acoustic insulation with improved durability and heat resistance, reduced cost, and flexibility in its formulation and use. The invention provides such an article, as well as a method for preparing such an article. These and other advantages of the invention, as well as additional inventive features, will be apparent from the description of the invention provided herein.

### BRIEF SUMMARY OF THE INVENTION

The invention provides a heat resistant insulation composite comprising, consisting essentially of, or consisting of (a) an insulation base layer comprising, consisting essentially of, or consisting of hollow, non-porous particles, a matrix binder, and, optionally, a foaming agent, and (b) a thermally reflective layer comprising, consisting essentially of, or consisting of a protective binder and an infrared reflecting agent, wherein the heat resistant insulation composite has a thermal conductivity of about 50 mW/(m·K) or less. A method for preparing a heat resistant insulation composite is also provided, which method comprises, consists essentially of, or consists of (a) providing on a substrate an insulation base layer comprising, consisting essentially of, or consisting of hollow, non-porous particles, a matrix binder, and, optionally, a foaming agent, and (b) applying to a surface of the insulation base layer a thermally reflective layer comprising, consisting essentially of, or consisting of a protective binder and an infrared reflecting agent, wherein the heat resistant insulation composite has a thermal conductivity of about 50 mW/(m·K) or less.

### DETAILED DESCRIPTION OF THE INVENTION

Heat Resistant Insulation Composite

The heat resistant insulation composite of the present invention comprises, consists essentially of, or consists of (a) an insulation base layer comprising, consisting essentially of, or consisting of hollow, non-porous particles, a matrix binder, and, optionally, a foaming agent, and (b) a thermally reflective layer comprising, consisting essentially of, or consisting of a protective binder and an infrared reflecting agent, wherein the heat resistant insulation composite has a thermal conductivity of about 50 mW/(m·K) or less.

Any suitable type of hollow, non-porous particle can be used in conjunction with the invention, including materials referred to as microballoons, microspheres, microbubbles, cenospheres, and other terms routinely used in the art. The term “non-porous,” as it is used in conjunction with the invention, means that the wall of the hollow particle does not allow the matrix binder to enter the interior space of the hollow particle to any substantial degree. By “substantial degree” is meant an amount that would increase the thermal conductivity of the particle or the insulation composite. The hollow, non-porous particles can be made of any suitable material, including organic and inorganic materials, and are preferably made from a material with a relatively low thermal conductivity. Organic materials include, for example, vinylidene chloride/acrylonitrile materials, phenolic materials, urea-formaldehyde materials, polystyrene materials, or thermoplastic resins. Inorganic materials include, for example, glass, silica, titania, alumina, quartz, fly ash, and ceramic materials. Furthermore, the heat resistant insulation composite can comprise a mixture of any of the foregoing types of hollow, non-porous particles (e.g., inorganic and organic hollow, non-porous particles). The interior space of the hollow particle typically will comprise a gas such as air (i.e., the hollow particles can comprise a shell of non-porous material encapsulating a gas). Suitable hollow, non-porous particles are commercially available. Examples of suitable hollow, non-porous particles include Scotchlite™ glass microspheres and Zeeospheres™ ceramic microspheres (both manufactured by 3M, Inc.). Suitable hollow, non-porous particles also include EXPANCEL® microspheres (manufactured by Akzo Nobel), which consist of a thermoplastic resin shell encapsulating a gas.

The size of the hollow, non-porous particles will depend, in part, on the desired thickness of the heat resistant insulation composite. For the purposes of the invention the terms “particle size” and “particle diameter” are used synonymously. Generally, larger particles provide greater thermal insulation; however, the particles should be relatively small compared with the thickness of the heat resistant insulation composite (e.g., the insulation base layer of the heat resistant insulation composite) so as to allow the matrix binder to surround the particles and form a matrix. For most applications, it is suitable to use hollow, non-porous particles having an average particle diameter (by weight) of about 5 mm or less (e.g., about 0.01-5 mm). Typically, the particles will have an average particle diameter (by weight) of about 0.001 mm or more (e.g., about 0.005 mm or more, or about 0.01 mm or more). Preferably, the particles have an average particle diameter (by weight) of about 3 mm or less (e.g., about 0.015-3 mm, about 0.02-3 mm, or about 0.1-3 mm) or about 2 mm or less (e.g., about 0.015-2 mm, about 0.02-2 mm, about 0.5-2 mm, or about 1-1.5 mm).

The hollow, non-porous particles used in conjunction with the invention can have a narrow particle size distribution. For example, the hollow, non-porous particles can have a particle size distribution such that at least about 95% of the particles (by weight) have a particle diameter of about 5 mm or less (e.g., about 0.01-5 mm), preferably about 3 mm or less (e.g., about 0.01-3 mm, about 0.015-3 mm, about 0.02-3 mm, or about 0.1-3 mm) or even about 2 mm or less (e.g., about 0.01-2 mm, about 0.01-5-2 mm, about 0.02-2 mm, about 0.5-2 mm, or about 1-1.5 mm). Desirably, the particles are approximately spherical in shape. Also, the hollow, non-porous particles can-have a bimodal particle size distribution, wherein the average particle sizes of the bimodal particle size distribution can be any of the above-described average particle sizes. Desirably, the ratio of the average particle sizes of the bimodal particle size distribution is at least about 8:1, such as at least about 10:1, or even at least about 12:1.

Any amount of the hollow, non-porous particles can be used in the heat resistant insulation composite. For example, the heat resistant insulation composite (e.g., the insulation base layer of the heat resistant insulation composite) can comprise about 5-99 vol. % of the hollow, non-porous particles based on the total liquid/solid volume of the insulation base layer. The total liquid/solid volume of the insulation base layer can be determined by measuring the volume of the combined liquid and solid components of insulation base layer (e.g., hollow, non-porous particles, matrix binder, foaming agent, etc.). If the insulation base layer (e.g., the matrix binder of the insulation base layer) is to be foamed, the total liquid/solid volume of the insulation base layer is the volume of the combined liquid and solid components of the insulation base layer prior to foaming. Of course, as the proportion of hollow, non-porous particles increases, the thermal conductivity of the heat resistant insulation composite decreases, thereby yielding enhanced thermal insulation performance; however, the mechanical strength and integrity of the insulation base layer decreases with increasing proportions of the hollow, non-porous particles due to a decrease in the relative amount of matrix binder used. Accordingly, it is often desirable to use about 50-95 vol. % hollow, non-porous particles in the insulation base layer, more preferably about 75-90 vol. % hollow, non-porous particles.

The insulation base layer of the heat resistant insulation composite can comprise any suitable matrix binder. The matrix binder can be an aqueous or non-aqueous binder, although aqueous binders are preferred due to their ease of use. The term aqueous binder, as used herein, refers to a binder that, prior to being used to prepare the insulation base layer, is water-dispersible or water-soluble. It is, therefore, to be understood that the term aqueous binder is used to refer to an aqueous binder in its wet or dry state (e.g., before or after the aqueous binder has been dried or cured, in which state the binder may no longer comprise water) even though the aqueous binder may not be dispersible or soluble in water after the binder has been dried or cured. Preferred aqueous matrix binders are those which, after drying, provide a water-resistant binder composition. Suitable non-aqueous matrix binders include acrylics, epoxies, butyral binders, polyethylene oxide binders, alkyds, polyesters, unsaturated polyesters, and other non-aqueous resins. Suitable aqueous matrix binders include, for example, acrylic binders, silicone-containing binders, phenolic binders, vinyl acetate binders, ethylene-vinyl acetate binders, styrene-acrylate binders, styrene-butadiene binders, polyvinyl alcohol binders, and polyvinyl-chloride binders, and acrylamide binders, as well as mixtures and co-polymers thereof. Preferred aqueous binders are aqueous acrylic binders. The matrix binder, whether aqueous or non-aqueous, can be used alone or in combination with suitable cross-linking agents.

The insulation base layer of the heat resistant insulation composite can comprise any amount of the matrix binder. For example, the insulation base layer can comprise 1-95 vol. % of the matrix binder based on the total liquid/solid volume of the insulation base layer. Of course, as the proportion of the matrix binder increases, the proportion of the hollow, non-porous particles necessarily decreases and, as a result, the thermal conductivity of the insulation base layer is increased. Accordingly, it is desirable to use as little of the matrix binder as needed to attain a desired amount of mechanical strength. For most applications, the insulation base layer comprises about 1-50 vol. % of the matrix binder, or about 5-25 vol. % of the matrix binder, or even about 5-10 vol. % of the matrix binder.

The insulation base layer can comprise opacifying agents, which reduce the thermal conductivity of the insulation base layer. Any suitable opacifying agent can be used, including, but not limited to, carbon black, carbon fiber, titania, or modified carbonaceous components as described, for example, in WO 96/18456A2.

The insulation base layer preferably comprises a foaming agent in addition to the matrix binder and hollow, non-porous particles. Without wishing to be bound by any particular theory, the foaming agent is believed to enhance the adhesion between the matrix binder and the hollow, non-porous particles. Also, the foaming agent is believed to improve the rheology of the matrix binder (e.g., for sprayable applications) and, especially, allows the matrix binder to be foamed by agitating or mixing (e.g., frothing) the combined matrix binder and foaming agent prior to or after the incorporation of the hollow, non-porous particles, although the foaming agent can be used without foaming the binder. In addition, a foamed binder can be advantageously used to provide a foamed insulation base layer having a lower density than a non-foamed base layer.

While the use of a foaming agent allows the matrix binder to be foamed by agitation or mixing, the matrix binder can, of course, be foamed using other methods, either with or without the use of a foaming agent. For example, the matrix binder can be foamed using compressed gasses or propellants, or the binder can be foamed by passing the binder through a nozzle (e.g., a nozzle that creates high-shear or turbulent flow).

Any suitable foaming agent can be used in the insulation base layer. Suitable foaming agents include, but are not limited to, foam-enhancing surfactants (e.g., non-ionic, cationic, anionic, and zwitterionic surfactants), as well as other commercially available foam enhancing agents, or mixtures thereof. The foaming agent should be present in an amount sufficient to enable the matrix binder to be foamed, if such foaming is desired. Preferably, about 0.1-5 wt. %, such as about 0.5-2 wt. %, of the foaming agent is used.

The insulation base layer may also comprise reinforcing fibers. The reinforcing fibers can provide additional mechanical strength to the insulation base layer and, accordingly, to the insulation composite. Fibers of any suitable type can be used, such as fiberglass, alumina, calcium phosphate, mineral wool, wollastonite, ceramic, cellulose, carbon, cotton, polyamide, polybenzimidazole, polyaramid, acrylic, phenolic, polyester, polyethylene, PEEK, polypropylene, and other types of polyolefins, or mixtures thereof. Preferred fibers are heat and fire resistant, as are fibers that do not have respirable pieces. The fibers also can be of a type that reflects infrared radiation, such as carbon fibers, metallized fibers, or fibers of other suitable infrared-reflecting materials. The fibers can be in the form of individual strands of any suitable length, which can be applied, for example, by spraying the/fibers onto the substrate with the other components of the insulation base layer (e.g., by mixing the fibers with one or more of the other components of the insulation base layer before spraying, or by separately spraying the fibers onto the substrate). Alternatively, the fibers can be in the form of webs or netting, which can be applied, for example, to the substrate, and the other components of the insulation base layer can be sprayed, spread, or otherwise applied over the web or netting. The fibers can be used in any amount sufficient to give the desired amount of mechanical strength for the particular application in which the heat resistant insulation composite will be used. Typically, the fibers are present in the insulation base layer in an amount of about 0.1-50 wt. %, desirably in an amount of about 0.5-20 wt. %, such as in an amount of about 1-10 wt. %, based on the weight of the insulation base layer.

The insulation base layer can have any desired thickness. Heat resistant insulation composites comprising thicker insulation base layers have greater thermal and/or acoustic insulation properties; however, the heat resistant insulation composite of the invention allows for the use of a relatively thin insulation base layer while still providing excellent thermal and/or acoustic insulation properties. For most applications, an insulation base layer that is about 1-15 mm thick, such as about 2-6 mm thick, provides adequate insulation.

The thermal conductivity of the insulation base layer will depend, in part, upon the particular formulation used to provide the insulation base layer. Desirably, the insulation base layer is formulated so as to have a thermal conductivity of about 50 mW/(m·K) or less, after drying. Preferably, the insulation base layer is formulated so as to have a thermal conductivity of about 45 mW/(m·K) or less, more preferably about 42 mW/(m·K) or less, or even about 40 mW/(m·K) or less (e.g., about 35 mW/(m·K)), after drying.

Similarly, the density of the insulation base layer will depend, in part, upon the particular formulation used to provide the insulation base layer. Preferably, the insulation base layer is formulated so as to have a density of about 0.5 g/cm³ or less, more preferably about 0.1 g/cm³ or less, most preferably about 0.08 g/cm³ or less, such as about 0.05 g/cm³ or less, after drying.

The thermally reflective layer of the heat resistant insulation composite comprises a protective binder. The thermally reflective layer imparts a higher degree of mechanical strength to the heat resistant insulation composite and/or protects the insulation base layer from degradation due to one or more environmental factors (e.g., heat, humidity, abrasion, impact, etc.). The protective binder can be any suitable binder that is resistant to the particular conditions (e.g., heat, stress, humidity, etc.) to which the heat resistant insulation composite will be exposed. Thus, the selection of the binder will depend, in part, upon the particular properties desired in the heat resistant insulation composite. The protective binder can be the same or different from the matrix binder of the insulation base layer. Suitable binders include aqueous and non-aqueous natural and synthetic binders. Examples of such binders include any of the aqueous and non-aqueous binders suitable for use in the insulation base layer, as previously described herein. Preferred binders are aqueous binders, such as aqueous acrylic binders. Especially preferred are self-crosslinking binders, such as self-crosslinking acrylic binders. The thermally reflective layer can contain hollow, non-porous particles, or can be substantially or completely free of hollow, non-porous particles. By substantially free of hollow, non-porous particles is meant that the thermally reflective layer contains hollow, non-porous particles in an amount of about 20 vol. % or less, such as about 10 vol. % or less, or even about 5 vol. % or less (e.g., about 1 vol. % or less).

The infrared reflecting agent can be any compound or composition that reflects or otherwise blocks infrared radiation, including opacifiers such as carbonaceous materials (e.g., carbon black), carbon fibers, titania (rutile), spinel pigments, and other metallic and non-metallic particles, pigments, and fibers, and mixtures thereof. Preferred infrared reflecting agents include metallic particles, pigments, and pastes, such as aluminum, stainless steel, bronze, copper/zinc alloys, and copper/chromium alloys. Aluminum particles, pigments, and pastes are especially preferred. In order to prevent the infrared reflecting agent from settling in the protective binder, the thermally reflective layer advantageously comprises an anti-sedimentation agent. Suitable anti-sedimentation agents include commercially available fumed metal oxides, clays, and organic suspending agents. Preferred anti-sedimentation agents are fumed metal oxides, such as fumed silica, and clays, such as hectorites. The thermally reflective layer also can comprise a wetting agent, such as a non-foaming surfactant.

Preferred formulations of the thermally reflective layer comprise reinforcing fibers. The reinforcing fibers can provide additional mechanical strength to the thermally reflective layer and, accordingly, to the insulation composite. Fibers of any suitable type can be used, such as fiberglass, alumina, calcium phosphate, mineral wool, wollastonite, ceramic, cellulose, carbon, cotton, polyamide, polybenzimidazole, polyaramid, acrylic, phenolic, polyester, polyethylene, PEEK, polypropylene, and other types of polyolefins, or mixtures thereof. Preferred fibers are heat and fire resistant, as are fibers that do not have respirable pieces. The fibers also can be of a type that reflects infrared radiation, and can be used in addition to, or instead of, the infrared reflecting agents previously mentioned. For example, carbon fibers or metallized fibers can be used, which provide both reinforcement and infrared reflectivity. The fibers can be in the form of individual strands of any suitable length, which can be applied, for example, by spraying the fibers onto the insulation base layer with the other components of the thermally reflective layer (e.g., by mixing the fibers with one or more of the other components of the thermally reflective layer before spraying, or by separately spraying the fibers onto the insulation base layer). Alternatively, the fibers can be in the form of webs or netting, which can be applied, for example, to the insulation base layer, and the other components of the thermally reflective layer can be sprayed, spread, or otherwise applied over the web or netting. The fibers can be used in any amount sufficient to give the desired amount of mechanical strength for the particular application in which the heat resistant insulation composite will be used. Typically, the fibers are present in the thermally reflective layer an amount of about 0.1-50 wt. %, desirably an amount of about 1-20 wt. %, such as an amount of about 2-10 wt. %, based on the weight of the thermally reflective layer.

The thickness of the thermally reflective layer will depend, in part, on the degree of protection and strength desired. While the thermally reflective layer can be any thickness, it is often desirable to keep the thickness of the heat resistant insulation composite to a minimum and, thus, to reduce the thickness of the thermally reflective layer to the minimum amount needed to provide an adequate amount of protection for a particular application. Generally, adequate protection can be provided by a thermally reflective layer that is about 1 mm thick or less.

The thermal conductivity of the heat resistant insulation composite will depend, primarily, on the particular formulation of the insulation base layer, although the formulation of the thermally reflective coating may have some effect. Desirably, the heat resistant insulation composite is formulated so as to have a thermal conductivity of about 50 mW/(m·K) or less, after drying. Preferably, the heat resistant insulation composite is formulated so as to have a thermal conductivity of about 45 mW/(m·K) or less, more preferably about 42 mW/(m·K) or less, or even about 40 mW/(m·K) or less (e.g., about 35 mW/(m·K)), after drying.

The term “heat resistant” as it is used to describe the insulation composite of the invention means that the insulation composite will not substantially degrade under high heat conditions. An insulation composite is considered to be heat resistant within the meaning of the invention if, after exposure to high-heat conditions for a period of 1 hour, the insulation composite retains at least about 85%, preferably at least about 90%, more preferably at least about 95%, or even at least about 98% or all of its original mass. Specifically, the high heat conditions are as provided using a 250 W heating element (IRB manufactured by Edmund Bühler GmbH, Germany) connected to a hot-air blower (HG3002 LCD manufactured by Steinel GmbH, Germany) with thin aluminum panels arranged around the device to form a tunnel. The insulation composite is exposed to the high heat conditions (thermally reflective layer facing the heating element) at a distance of about 20 mm from the heating element, wherein the hot air blower (at full blower setting and lowest heat setting) provides a continuous flow of air between the heating element and the insulation composite. Desirably, the heat resistant insulation composite does not visibly degrade under such conditions.

When the heat resistant insulation composite is to be used under conditions of a certain flammability classification, for example, where it could be exposed to open-flames or extremely high-temperature conditions, the insulation composite desirably includes a suitable fire retardant. The fire retardant can be included in the insulation base layer and/or the thermally reflective layer of the heat resistant insulation composite. Suitable fire retardants include aluminum hydroxides, magnesium hydroxides, ammonium polyphosphates and various phosphorus-containing substances, and other commercially available fire retardants and intumescent agents.

The heat resistant insulation composite (e.g., the insulation base layer and/or the thermally reflective layer of the insulation composite) may additionally comprise other components, such as any of various additives known in the art. Examples of such additives include rheology control agents and thickeners, such as fumed silica, polyacrylates, polycarboxylic acids, cellulose polymers, as well as natural gums, starches and dextrins. Other additives include solvents and co-solvents, as well as waxes, surfactants, and curing and cross-linking agents, as required.

Method for Preparing a Heat Resistant Insulation Composite

The invention further provides a method for preparing a heat resistant insulation composite comprising, consisting essentially of, or consisting of (a) providing on a substrate an insulation base layer comprising, consisting essentially of, or consisting of hollow, non-porous particles, a matrix binder, and, optionally, a foaming agent, and (b) applying to a surface of the insulation base layer a thermally reflective layer comprising a protective binder and an infrared reflecting agent, wherein the heat resistant insulation composite has a thermal conductivity of about 50 mW/(m·K) or less. The various elements of the heat resistant insulation composite prepared in accordance with this method are as previously-described herein.

The insulation base layer can be provided by any suitable method. For example, the hollow, non-porous particles and matrix binder can be combined by any suitable method to form an particle-containing binder composition, which then can be applied to the substrate to form an insulation base layer, for example, by spreading or spraying the particle-containing binder composition on the substrate.

Preferably, however, the insulation base layer is provided by (a) providing a binder composition comprising, consisting essentially of, or consisting of a matrix binder and a foaming agent, (b) agitating the binder composition to provide a foamed binder composition, (c) combining the foamed binder composition with the hollow, non-porous particles to provide an particle-containing binder composition, and (d) applying the particle-containing binder composition to the substrate to provide the insulation base layer. Alternatively, the insulation base layer can be provided by (a) providing a binder composition comprising, consisting essentially of, or consisting of a matrix binder and, optionally, a foaming agent to provide a binder composition, (b) providing an particle composition comprising, consisting essentially of, or consisting of hollow, non-porous partilces, and (c) simultaneously applying the binder composition and the particle composition to the substrate, wherein the binder composition is mixed with the particle composition to provide the insulation base layer.

The particle composition comprises, consists essentially of, or consists of hollow, non-porous particles, as previously described herein, and, optionally, a suitable vehicle. The binder composition and/or particle composition can be applied to the substrate in accordance with the invention (e.g., together or separately) by any suitable method, such as by spreading or, preferably, spraying the binder composition and/or particle composition or the components thereof onto the substrate. By “simultaneously applying” is meant that the particle composition and the binder composition are separately delivered to the substrate at the same time, wherein the particle composition and the binder composition are mixed during the delivery process (e.g., mixed in the flow path or on the substrate surface). This can be accomplished, for example, by simultaneously spraying the particle composition and the binder composition on the substrate, whereby the particle composition and binder composition are delivered via separate flowpaths. The flowpaths can be joined within the spraying apparatus, such that a combined particle-binder composition is delivered to the substrate, or the flowpaths can be entirely separate, such that the particle composition is not combined with the binder composition until the respective compositions reach the substrate.

By combining the binder composition with the hollow, non-porous particles in the manner described herein, a particle-containing binder composition having desirable properties can be provided. In particular, and without wishing to be bound to any particular theory, the particle-containing binder composition produced in accordance with the invention exhibit a reduced tendency of the hollow, non-porous particles to separate from the composition, thereby maintaining a uniform dispersion in the composition and increasing the thermal conductivity of the composition. Also, the method of the invention enables the use of a high particle to binder ratio, which enhances the thermal performance of the particle-containing binder composition and reduces the density of the composition. Furthermore, the method of the invention provides a sprayable particle-containing binder composition, allowing flexibility in its application and use. The hollow, non-porous particles, binder composition, and foaming agent are as previously described herein.

While the binder, alone or in combination with the foaming agent, is, preferably, foamed by agitation or mixing, other foaming methods can be used. For example, the binder can be foamed using compressed gasses or propellants, or the binder can be foamed by passing the binder through a nozzle (e.g., a nozzle that creates high-shear or turbulent flow).

The thermally reflective layer of the heat resistant insulation composite can be applied to the surface of the insulation base layer by any suitable method. The components of the thermally reflective layer are as previously described herein. Preferably, the components of the thermally reflective layer are combined, with mixing, to provide a thermally reflective coating composition, which then is applied to the surface of the insulation base layer by any suitable method, for example, by spreading or spraying.

While adhesives or coupling agents may be used to adhere the thermally reflective layer to the insulation base layer, such adhesives are not needed in accordance with the invention inasmuch as the binder in the insulation base layer or thermally reflective layer can provide desired adhesion. The thermally reflective layer is, preferably, applied to the insulation base layer while the insulation base layer is wet, but can be applied after the insulation base layer has been dried. The heat resistant insulation composite (e.g., the insulation base layer and/or the thermally reflective layer of the heat resistant insulation composite) can be dried under ambient conditions or with heating, for example, in an oven.

Applications and End-Uses

The heat resistant insulation composite of the invention, as well as the methods for its preparation, can, of course, be used for any suitable purpose. However, the heat resistant insulation composite of the invention is especially suited for applications demanding insulation that provides thermal stability, mechanical strength, and/or flexibility in the mode of application. For instance, the heat-resistant insulation composite, according to preferred formulations, especially sprayable formulations, is useful for insulating surfaces from high temperatures and can be easily applied to surfaces which might otherwise be difficult or costly to protect by conventional methods. Examples of such applications include various components of motorized vehicles and devices, such as the engine compartment, firewall, fuel tank, steering column, oil pan, trunk and spare tire, or any other component of a motorized vehicle or device. The heat resistant insulation composite is especially well suited for insulating the underbody of a motorized vehicle, especially as a shield for components near the exhaust system. Of course, the heat resistant insulation composite of the invention can be used to provide insulation in many other applications. For instance, the heat resistant insulation composite can be used to insulate pipes, walls, and heating or cooling ducts. While preferred formulations of the heat resistant insulation composite are sprayable formulations, the heat resistant insulation composite can also be extruded or molded to provide insulation articles such as tiles, panels, or various shaped articles. In this regard, the invention also provides a substrate, such as any of those previously mentioned, comprising the heat resistant insulation composite of the invention, as well as a method for insulating a substrate comprising the use of any of the heat resistant insulation composite, or methods for its preparation or use.

The following examples further illustrate the invention but, of course, should not be construed as in any way limiting its scope.

### EXAMPLE 1

This example illustrates the preparation and performance of a heat resistant insulation composite in accordance with the invention.

A particle-containing matrix binder composition (Sample 1A) was prepared by combining 200 g of an aqueous acrylic binder (LEFASOL™ 168/1 manufactured by Lefatex Chemie GmbH, Germany), 1.7 g of a foaming agent (HOSTAPUR™ OSB manufactured by Clariant GmbH, Germany), and 30 g of an ammonium polyphosphate fire retardant (EXOLIT™ AP420 manufactured by Clariant GmbH, Germany) in a conventional mixer. The binder composition was mixed until 3 dm³ of a foamed binder composition was obtained. Subsequently, 100 g of hollow, non-porous, glass microspheres (B23/500 glass microspheres manufactured by 3M, Minneapolis, Minn.) were slowly added with mixing to maintain the volume at 3 dm³, thereby providing an particle-containing binder composition.

Two other particle-containing binder compositions were prepared (Samples 1B and 1C) in the same manner as Sample 1A, above, except that perlite (Staubex™ manufactured by Deutsche Perlite GmbH, Germany) and bitumenized perlite (Thermoperl™ manufactured by Deutsche Perlite GmbH, Germany) were used instead of the glass microspheres.

Each of the compositions were spread using a spatula into a frame lined with aluminum foil measuring approximately 25 cm in length and width, and approximately 1.5 cm in depth. The compositions were dried for two hours at 130° C. After the compositions had cooled, 20 cm by 20 cm samples were cut from the frames, and the thermal conductivity of each sample was measured using a LAMBDA CONTROL™ A50 thermal conductivity instrument (manufactured by Hesto Elektronik GmbH, Germany) with an upper platen temperature of 36° C. and a lower platen temperature of 10° C. The densities of the samples were determined by dividing the weight of each sample by its dimensions. The results are provided in Table 1.

TABLE 1

| | | | Thermal | |
|---|---|---|---|---|
| | | | Conductivity | |
| | | Density | (mW · | |
| Sample | Particulate | (g/cm³) | m⁻¹ · K⁻¹) | Observations |
| 1A | Glass | 0.08 | 42 | Composite was |
| | Microspheres | | | white, soft, |
| | | | | and self-supporting |
| 1B | Perlite | 0.11 | 53 | Composite was |
| | | | | rigid and |
| | | | | friable with |
| | | | | large voids |
| | | | | between particles |
| 1C | Bitumenized | 0.17 | 63 | Composite was |
| | Perlite | | | rigid and |
| | | | | friable with |
| | | | | large voids |
| | | | | between particles |

As demonstrated by these results, the particle-containing binder composition, which can be used as the insulation base layer in a heat resistant insulation composite according to the invention, provides lower thermal conductivity and lower density than compositions prepared using other particulate materials. Furthermore, the particle-containing binder composition is less friable and not as rigid as other composites.

The particle-containing binder composition can be applied to a substrate as an insulation base layer, to which a thermally reflective coating can be applied to form a heat resistant insulation composite. A thermally reflective coating composition can be prepared, for example, by combining 58 g of an aqueous acrylic binder (WORLEECRYL™ 1218 manufactured by Worlee Chemie GmbH, Germany) with 22.6 g of a fumed silica anti-sedimentation agent (CAB-O-SPERSE™ manufactured by Cabot Corporation, Massachusetts) and 19.4 g of an aluminum pigment paste as an infrared reflecting agent (STAPA™ Hydroxal WH 24 n.l. manufactured by Eckart GmbH, Germany). The composition can be gently mixed using a magnetic stirrer. After mixing, the coating composition can be applied to the insulation base layer, for example, by spraying to a thickness of approximately 1 mm, preferably before drying the insulation base layer.

The particle-containing insulation composite thus prepared provides excellent heat resistance as compared to the same insulation base layer in the absence of the thermally reflective coating, while retaining a low thermal conductivity and low density.

### EXAMPLE 2

This example illustrates the preparation and performance of a heat resistant insulation composite in accordance with the invention.

A particle-containing matrix binder composition (Sample 2A) was prepared by combining 200 g of an aqueous acrylic binder (WORLEECRYL™ 1218 manufactured by Worlee Chemie GmbH, Germany), 1.2 g of a foaming agent (HOSTAPUR™ OSB manufactured by Clariant GmbH, Germany), and 10 g of water in an Oakes foamer (available from E.T. Oakes Corporation, Hauppauge, N.Y.) using a rotor-stator speed of about 1000 rpm, a pump speed of about 25% capacity, and an air flow of about 2.4 dm³/min. Subsequently, 15 g of hollow, non-porous, thermoplastic resin microspheres (EXPANCEL® 091 DE 40 d30 microspheres manufactured by Akzo Nobel) were slowly added using a conventional mixer to maintain the volume of the mixture, thereby providing an particle-containing binder composition.

A second particle-containing binder composition was prepared (Sample 2B) in the same manner as Sample 2A, above, except that a mixture of hollow, non-porous, thermoplastic resin microspheres and hollow, non-porous, glass microspheres was used instead of the hollow, non-porous, thermoplastic resin microspheres alone. In particular, the mixture consisted of 38.3 g of hollow, non-porous, thermosplastic resin microspheres (specifically, 5 g of EXPANCEL® 091 DE 40 d30 microspheres and 33.3 g of EXPANCEL® 551WE 40 d36 microspheres (both manufactured by Akzo Nobel)) and 45 g of hollow, non-porous, glass microspheres (B23/500 glass microspheres manufactured by 3M, Minneapolis, Minn.). Each type of hollow, non-porous particle comprised the same amount by volume of the total hollow, non-porous particle composition. Furthermore, the volume percent of hollow, non-porous particles in Sample 2B was equal to that of Sample 2A.

Each of the compositions was spread using a spatula into an aluminum foil-lined frame measuring approximately 25 cm in length and width, and approximately 1.5 cm in depth. The compositions were dried for two hours at 130° C. After the compositions had cooled, 20 cm by 20 cm samples were cut from the frames, and the thermal conductivity of each sample was measured using a LAMBDA CONTROL™ A50 thermal conductivity instrument (manufactured by Hesto Elektronik GmbH, Germany) with an upper platen temperature of 36° C. and a lower platen temperature of 10° C. The densities of the samples were determined by dividing the weight of each sample by its dimensions. The results are provided in Table 2.

TABLE 2

| | | | Thermal | |
|---|---|---|---|---|
| | | | Conductivity | |
| | | Density | (mW· | |
| Sample | Particulate | (g/cm³) | m⁻¹ · K⁻¹) | Observations |
| 2A | Thermoplastic resin | 0.059 | 34.2 | Composite |
| | microspheres | | | was slightly |
| | | | | yellow and |
| | | | | self-supporting |
| 2B | Thermoplastic resin | 0.066 | 39.7 | Composite |
| | microspheres and | | | was rigid |
| | glass microspheres | | | and slightly |
| | | | | brittle |

As demonstrated by these results, the particle-containing binder compositions, which can be used as the insulation base layer in a heat resistant insulation composite according to the invention, provide low thermal conductivity and low density.

### EXAMPLE 3

This example illustrates the heat resistance of an insulation composite of the invention.

A thermally reflective coating composition was prepared by combining 58 g of an aqueous acrylic binder (WORLEECRYL™ 1218 manufactured by Worlee Chemie GmbH, Germany) with 22.6 g of a fumed silica anti-sedimentation agent (CAB-O-SPERSE™ manufactured by Cabot Corporation, Massachusetts) and 19.4 g of an aluminum pigment paste as an infrared reflecting agent (STAPA™ Hydroxal WH 24 n.l. manufactured by Eckart GmbH, Germany). The mixture was gently mixed using a magnetic stirrer.

The thermally reflective coating composition was then applied to the particle-containing binder compositions of Example 2 (Sample 2A and Sample 2B) to a thickness of approximately 1 mm, thereby yielding insulation composites having an insulation base layer and a thermally reflective layer (Sample 3A and Sample 3B, respectively). The thermally reflective coating composition was also applied to a third particle-containing composition to yield a third insulation composite (Sample 3C). The third particle-containing composition was prepared in the same manner as Sample 2A, except for the amount and specific type that of hollow, non-porous, thermoplastic resin microspheres (100 g of EXPANCEL® 551 WE 40 d36 179.2 microspheres (available from Akzo Nobel) were used).

Each of the insulation composites was then placed in an apparatus designed to determine the heat resistance of the insulation composite. In particular, the apparatus comprised a 250 W heating element (IRB manufactured by Edmund Buhler GmbH, Germany) connected to a hot-air blower (HG3002 LCD manufactured by Steinel GmbH, Germany) with thin aluminum panels arranged around the device to form a tunnel. The insulation composite was exposed to the high heat conditions for about 30 minutes at a distance of about 20 mm from the heating element (thermally reflective layer facing the heating element), and the hot air blower (at full blower setting and lowest heat setting) provided a continuous flow of air between the heating element and the insulation composite. The temperature of the backside of the insulation composite (i.e., the side opposite the thermally reflective layer and the heating element) was monitored throughout the test to determine the maximum sustained temperature. The results of these measurements are provided in Table 3.

TABLE 3

| | | Backside |
|---|---|---|
| | | Temperature |
| Sample | Particulate | (° C.) |
| 3A | Thermoplastic resin | 27 |
| | microspheres | |
| 3B | Thermoplastic resin | 25 |
| | microspheres and | |
| | glass microspheres | |
| 3C | Thermoplastic resin | 28 |
| | microspheres | |

These results demonstrate that the insulation composite of the invention is heat resistant and exhibits good thermal insulation properties under high heat conditions.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A heat resistant insulation composite comprising
(a) an insulation base layer comprising hollow, non-porous particles and a matrix binder, and
(b) a thermally reflective layer comprising an infrared reflecting agent and a protective binder,
wherein the heat resistant insulation composite has a thermal conductivity of about 50 mW/(m·K) or less.

2. The heat resistant insulation composite of claim 1, wherein the hollow, non-porous particles have an average particle diameter (by weight) of about 0.1-5 mm.

3. The heat resistant insulation composite of claim 2, wherein the hollow, non-porous particles have an average particle diameter (by weight) of about 0.01-2 mm

4. The heat resistant insulation composite of claim 3, wherein at least about 95% of the hollow, non-porous particles (by weight) have a particle diameter of about 0.01-2 mm.

5. The heat resistant insulation composite of claim 1, wherein the insulation base layer further comprises an opacifying agent.

6. The heat resistant insulation composite of claim 5, wherein the opacifying agent is titania, carbon black, or a mixture thereof.

7. The heat resistant insulation composite of claim 1, wherein the hollow, non-porous particles are approximately spherical.

8. The heat resistant insulation composite of claim 1, wherein the insulation base layer comprises 5-99 vol. % hollow, non-porous particles.

9. The heat resistant insulation composite of claim 8, wherein the insulation base layer comprises 1-95 vol. % matrix binder.

10. The heat resistant insulation composite of claim 1, wherein the insulation base layer comprises a foaming agent.

9. The heat resistant insulation composite of claim 1, wherein the matrix binder is an aqueous binder.

10. The heat resistant insulation composite of claim 11, wherein the aqueous binder is selected from the group consisting of an acrylic binder, a silicone-containing binder, a phenolic binder, and a mixture thereof.

11. The heat resistant insulation composite of claim 12, wherein the aqueous binder is an aqueous acrylic binder.

12. The heat resistant insulation composite of claim 11, wherein the matrix binder is a foamed binder.

13. The heat resistant insulation composite of claim 1, wherein the insulation base layer further comprises a flame retardant.

14. The heat resistant insulation composite of claim 1, wherein the insulation base layer is about 1-10 mm thick.

15. The heat resistant insulation composite of claim 1, wherein the insulation base layer has a thermal conductivity of about 45 mW/(m·K) or less after drying.

16. The heat resistant insulation composite of claim 1, wherein the insulation base layer has a density of about 0.5 g/cm³ or less after drying.

17. The heat resistant insulation composite of claim 1, wherein the protective binder is an acrylic binder, a silicone-containing binder, a phenolic binder, or a mixture thereof.

18. The heat resistant insulation composite of claim 19, wherein the protective binder is an acrylic binder.

19. The heat resistant insulation composite of claim 19, wherein the protective binder is a cross-linked binder.

20. The heat resistant insulation composite of claim 1, wherein the thermally reflective layer further comprises an anti-sedimentation agent.

21. The heat resistant insulation composite of claim 1, wherein the infrared reflecting agent comprises metallic particles.

22. The heat resistant insulation composite of claim 23, wherein the metallic particles are aluminum particles.

23. The heat resistant insulation composite of claim 1, wherein the thermally reflective layer further comprises a flame retardant.

24. The heat resistant insulation composite of claim 1, wherein the thermally reflective layer is about 1 mm thick or less.

25. The heat resistant insulation composite of claim 1, wherein the thermally reflective layer further comprises reinforcing fibers.

26. The heat resistant insulation composite of claim 27, wherein the thermally reflective layer further comprises carbon fibers.

27. A substrate comprising the heat resistant insulation composite of claim 1.

28. The substrate of claim 29, wherein the substrate is a component of a motorized vehicle or device.

29. The substrate of claim 30, wherein the substrate is the underbody of a motorized vehicle or part thereof.

30. A method for preparing a heat resistant insulation composite comprising
(a) providing on a substrate an insulation base layer comprising hollow, non-porous particles and a matrix binder, and
(b) applying to a surface of the insulation base layer a thermally reflective layer comprising a protective binder and an infrared reflecting agent,
wherein the heat resistant insulation composite has a thermal conductivity of about 50 mW/(m·K) or less.

31. The method of claim 32, wherein the insulation base layer is provided by
(a) providing a binder composition comprising a matrix binder and a foaming agent,
(b) agitating the binder composition to provide a foamed binder composition,
(c) combining the foamed binder composition with the hollow, non-porous particles to provide a particle-containing binder composition, and
(d) applying the particle-containing binder composition to the substrate to provide the insulation base layer.

34. The method of claim 33, wherein the insulation base layer is applied to the substrate by spraying.

35. The method of claim 34, wherein the thermally reflective layer is applied to the surface of the insulation base layer by spraying.

36. The method of claim 35, wherein the thermally reflective layer is applied to the surface of the insulation base layer while the insulation base layer is wet.

37. The method of claim 32, wherein the insulation base layer is provided by
(a) providing a binder composition comprising a matrix binder,
(b) providing a particle composition comprising hollow, non-porous particles, and
(c) simultaneously applying the binder composition and the particle composition to the substrate, wherein the binder composition is mixed with the particle composition to provide the insulation base layer.

38. The method of claim 37, wherein the insulation base layer is applied to the substrate by spraying.

39. The method of claim 38, wherein the thermally reflective layer is applied to the surface of the insulation base layer by spraying.

40. The method of claim 39, wherein the thermally reflective layer is applied to the surface of the insulation base layer while the insulation base layer is wet.

41. The method of claim 32, wherein the insulation base layer is applied to the substrate by spraying.

42. The method of claim 41, wherein the thermally reflective layer is applied to the surface of the insulation base layer by spraying.

43. The method of claim 42, wherein the thermally reflective layer is applied to the surface of the insulation base layer while the insulation base layer is wet.

44. The method of claim 32, wherein the hollow, non-porous particles have an average particle diameter (by weight) of about 0.01-5 mm.

45. The method of claim 44, wherein the hollow, non-porous particles have an average particle diameter (by weight) of about 0.01-2 mm

46. The method of claim 45, wherein at least about 95% of the hollow, non-porous particles (by weight) have a particle diameter of about 0.01-2 mm.

47. The method of claim 32, wherein the insulation base layer further comprises an opacifying agent.

48. The method of claim 47, wherein the opacifying agent is titania or carbon black.

49. The method of claim 32, wherein the hollow, non-porous particles are approximately spherical.

50. The method of claim 32, wherein the insulation base layer comprises 5-99 vol. % hollow, non-porous particles.

51. The method of claim 50, wherein the insulation base layer comprises 1-95 vol. % matrix binder.

52. The method of claim 32, wherein the insulation base layer comprises a foaming agent.

53. The method of claim 32, wherein the matrix binder is an aqueous binder.

54. The method of claim 53, wherein the aqueous binder is selected from the group consisting of an acrylic binder, a silicone-containing binder, a phenolic binder, and a mixture thereof.

55. The method of claim 54, wherein the aqueous binder is an acrylic binder.

56. The method of claim 53, wherein the binder is a foamed binder.

57. The method of claim 32, wherein the insulation base layer further comprises a flame retardant.

58. The method of claim 32, wherein the insulation base layer is about 1-15 mm thick.

59. The method of claim 32, wherein the insulation base layer has a thermal conductivity of about 45 mW/(m·K) or less after drying.

60. The method of claim 32, wherein the insulation base layer has a density of about 0.5 g/cm³ or less after drying.

61. The method of claim 32, wherein the protective binder is an acrylic binder, a silicone-containing binder, a phenolic binder, or a mixture thereof.

62. The method of claim 61, wherein the protective binder is an acrylic binder.

63. The method of claim 61, wherein the protective binder is a cross-linked binder.

64. The method of claim 32, wherein the thermally reflective layer further comprises an anti-sedimentation agent.

65. The method of claim 32, wherein the infrared reflecting agent comprises metallic particles.

66. The method of claim 65, wherein the metallic particles are aluminum particles.

67. The method of claim 32, wherein the thermally reflective layer further comprises a flame retardant.

68. The method of claim 32, wherein the thermally reflective layer is about 1 mm thick or less.

69. The method of claim 32, wherein the thermally reflective layer further comprises reinforcing fibers.

70. The method of claim 32, wherein the thermally reflective layer further comprises carbon fibers.
